(19) United States
(12) Patent Application Publication
(10) Pub. No.: US 2019/0050020 A1
(43) Pub. Date: Feb. 14, 2019

(54) Clock Signal Staggering with Clock Frequency Adjustment

(71) Applicant: Qualcomm Incorporated, San Diego, CA (US)

(72) Inventor: Jeffrey Hao Chu, San Diego, CA (US)

(21) Appl. No.: 15/674,431

(22) Filed: Aug. 10, 2017

(51) Int. Cl. G06F 1/12; G06F 1/06

(52) U.S. Cl. CPC G06F 1/12; G06F 1/06

(57) ABSTRACT

An integrated circuit is disclosed for clock signal staggering with clock frequency adjustment. In an example aspect, the integrated circuit includes a clock source, a clock-signal controller, and a core. The clock source produces a core clock signal having a core frequency and performs an adjustment of the core frequency. The clock-signal controller generates a clock adjustment indicator signal indicative of the adjustment of the core frequency of the core clock signal. The core is coupled to the clock source and receives the core clock signal. The core includes multiple partitions that perform operations responsive to oscillation of the core clock signal at the core frequency. The core also includes clock stagger circuitry that is coupled to the clock-signal controller. The clock stagger circuitry sequentially provides the core clock signal to individual partitions of the multiple partitions based on the clock adjustment indicator signal.

### TECHNICAL FIELD

This disclosure relates generally to power management with integrated circuits (ICs) that are used in electronic devices and, more specifically, to hardware-controlled current management that supports a clock frequency adjustment by staggering the reintroduction of an oscillating clock signal to a core after a frequency-adjustment operation has been performed on the clock signal.

### BACKGROUND

Power consumption by electronic devices is an increasingly important factor in the design of electronic devices. From a global perspective, the energy consumption of electronic devices occupies a sizable percentage of total energy usage due to large corporate data centers and the ubiquity of personal computing devices. Environmental concerns thus motivate efforts to reduce the power consumed by electronic devices to help conserve the earth's resources. From an individual perspective, less power consumption translates to lower energy bills. Furthermore, many personal computing devices are portable and powered by batteries. A portable, battery-powered electronic device can operate longer without recharging the battery if the device consumes less energy. Lower energy consumption also enables the use of smaller batteries and the adoption of thinner form factors, which means electronic devices can be made more portable or versatile. Thus, the popularity of portable devices also motivates efforts to reduce the power consumption of electronic devices.

An electronic device consumes power if the device is coupled to a power source and is turned on. This is true for the entire electronic device, but it is also true for individual parts of the electronic device. Hence, power consumption can be reduced if parts of an electronic device are powered down, even while other parts remain powered up. Entire discrete components of an electronic device, such as a whole integrated circuit (IC) or a Wi-Fi radio, may be powered down. Alternatively, selected parts of a discrete component may likewise be powered down. For example, a core of an integrated circuit chip, such as a distinct processing entity or a circuit block, may be selectively powered down for some period of time to reduce energy consumption.

A portion of an integrated circuit, such as a core, can therefore be powered down to reduce energy usage and extend battery life. A core can be powered down by decoupling the core from a power source or by turning the power source off. Alternatively, core power can be managed by decreasing a voltage level supplied to the core and by reducing the frequency of operation of the core. Decreasing both of these parameters can reduce power consumption. One approach to decreasing a voltage or a frequency of a core while maintaining the desired processing throughput of an integrated circuit is called dynamic voltage and frequency scaling (DVFS). With DVFS, energy usage by a core can be managed by lowering a supply voltage or a clock frequency during times of reduced utilization and then raising the voltage or frequency at other times to meet higher processing demands. By averaging times of lower and higher voltage and clock frequency usage, the net effect is power and energy savings as compared to statically running the core at the higher processing voltage and frequency levels.

Thus, using DVFS as a power management technique with integrated circuits can reduce the power consumption of electronic devices. Unfortunately, implementing DVFS is challenging. For example, implementation of DVFS can adversely impact the performance provided by an integrated circuit, especially during periods of voltage or frequency transition. During a transitional period to adjust a supply voltage level or a frequency of operation, processing throughput for a core is typically slowed or actually paused. Moreover, data can be corrupted as a result of a voltage or frequency adjustment operation. These problems hinder the deployment of DVFS and consequently can prevent full power-conserving benefits of DVFS from being attained.

### SUMMARY

An integrated circuit (IC) is disclosed that implements clock signal staggering with clock frequency adjustment. In an example aspect, an integrated circuit is disclosed that includes a clock source, a clock-signal controller, and a core. The clock source is configured to produce a core clock signal having a core frequency and to perform an adjustment of the core frequency. The clock-signal controller is configured to generate a clock adjustment indicator signal indicative of the adjustment of the core frequency of the core clock signal. The core is coupled to the clock source and is configured to receive the core clock signal. The core includes multiple partitions and clock stagger circuitry. The multiple partitions are configured to perform operations responsive to oscillation of the core clock signal at the core frequency. The clock stagger circuitry is coupled to the clock-signal controller and is configured to receive the clock adjustment indicator signal. The clock stagger circuitry is further configured to sequentially provide the core clock signal to individual partitions of the multiple partitions based on the clock adjustment indicator signal.

In an example aspect, an integrated circuit is disclosed. The integrated circuit includes a clock source, a clock-signal controller, and a core coupled to both the clock source and the clock-signal controller. The clock source is configured to produce a core clock signal and to adjust a core frequency of the core clock signal. The clock-signal controller is configured to generate a clock adjustment indicator signal indicative of an adjustment of the core frequency. The core is configured to receive the core clock signal and the clock adjustment indicator signal, with the core further configured to operate based on the core frequency of the core clock signal. The core includes multiple partitions that are configured to perform operations responsive to oscillation of the core clock signal. The core also includes means for staggering release of the core clock signal to individual partitions of the multiple partitions based on the clock adjustment indicator signal.

In an example aspect, a method for clock signal staggering with clock frequency adjustment is disclosed. The method includes generating a clock adjustment indicator signal indicative of a frequency-adjustment operation of a core clock signal of a core. The method also includes gating, for the frequency-adjustment operation, multiple versions of the core clock signal of the core. The method additionally includes implementing a delay period based on the clock adjustment indicator signal. The method further includes providing the multiple versions of the core clock signal to multiple partitions of the core at different times based on the delay period.

In an example aspect, an integrated circuit is disclosed. The integrated circuit includes a clock source and a core coupled to the clock source. The clock source is configured to perform a frequency-adjustment operation on a core frequency of a core clock signal. The core is configured to receive the core clock signal and to operate based on the core frequency of the core clock signal. The core includes clock control circuitry, a first partition, and a second partition. The clock control circuitry is configured to generate a first version of the core clock signal using the core clock signal and a second version of the core clock signal using the core clock signal. The first partition is coupled to the clock control circuitry and is configured to operate responsive to the first version of the core clock signal. The second partition is coupled to the clock control circuitry and is configured to operate responsive to the second version of the core clock signal. The clock control circuitry is further configured to delay forwarding of the first version relative to the second version after the frequency-adjustment operation has been performed.

### BRIEF DESCRIPTION OF DRAWINGS

FIG. 1 illustrates a portion of an example integrated circuit that includes a power rail that is coupled to a core in which clock signal staggering with clock frequency adjustment can be implemented in conjunction with a clock source and a clock-signal controller.

FIG. 2 illustrates an example integrated circuit portion that includes a core, a clock source, and a clock-signal controller, with the clock-signal controller generating a clock adjustment indicator signal to indicate to clock control circuitry an occurrence of a frequency-adjustment operation.

FIG. 3 illustrates an example scheme for how the clock source can adjust a core frequency of the core clock signal and how the clock control circuitry can handle the frequency-adjustment operation based on the clock adjustment indicator signal.

FIG. 4 illustrates an example approach to the production and manipulation of multiple versions of the core clock signal that are routed within the core to handle a restart of the core clock signal after the frequency-adjustment operation.

FIG. 5 illustrates an example sequential release of the multiple versions of the core clock signal so that multiple partitions can be reactivated at different times.

FIG. 6 illustrates an example of clock control circuitry that includes clock gating circuitry and clock stagger circuitry, with the clock stagger circuitry including multiple delay units.

FIG. 7 illustrates an example of clock stagger circuitry in which the multiple delay units are implemented using multiple flip-flops.

FIG. 8 illustrates an example of clock stagger circuitry with a programmable delay period for the release of the multiple versions of the core clock signal.

FIG. 9 depicts an example signal timing diagram including different clock signals, a control signal, multiple clock enable signals, and multiple versions of the core clock signal.

FIG. 10 is a flow diagram illustrating an example process for clock signal staggering with clock frequency adjustment.

FIG. 11 illustrates an example electronic device that includes an integrated circuit having multiple cores that can implement clock signal staggering with clock frequency adjustment.

### DETAILED DESCRIPTION

Power consumption by electronic devices can be managed by controlling an amount of energy that an integrated circuit (IC) uses over time or on an instantaneous basis. Energy usage can be reduced to zero or near zero if an integrated circuit is powered down completely, such as if a device is asleep. Even if a device is awake and operational, an integrated circuit may still be capable of being powered down partially. If a device is to be operated in a mode to save power while maintaining a desired level of throughput, an integrated circuit can be operated at higher and lower power levels at different times to achieve an average power usage level that may not be achievable with any single power level. Thus, an average power usage level can be achieved by operating an integrated circuit at a lower voltage level and lower clock frequency to reduce power consumption during some time periods that are then averaged with the duration of times at which the integrated circuit is running at a higher voltage level and higher clock frequency.

Further, power usage by an integrated circuit can be managed by adjusting voltage and frequency for one or more portions, or cores, of the integrated circuit. Thus, dynamic voltage and frequency scaling (DVFS) can be implemented on a core-by-core basis. If DVFS is implemented for an individual core, a voltage level of a voltage supply for the core or a frequency of a clock signal for the core can be adjusted to accommodate performance demands. With DVFS, an ability to meet performance demands can be maintained while adjusting the voltage and frequency to achieve lower average power. Direct power savings result when the voltage is lowered, which is a function of lowering the clock frequency. Typically, if the frequency is increased, the voltage is also increased. This direct relationship between voltage and frequency levels is usually adopted because circuitry can begin to malfunction if the clock frequency is increased too much without also increasing the voltage supply level. Nevertheless, a clock frequency can be adjusted independently of a voltage supply, so a frequency-adjustment operation is described herein separately from any potential corresponding voltage changes that may also be implemented.

With an example frequency-adjustment operation, a core is switched from being operated at one clock frequency to being operated at another clock frequency. Because a given core of an integrated circuit typically consumes less energy if operated at a lower voltage level, power consumption of the integrated circuit can be reduced by decreasing the clock frequency, which permits a lowering of the voltage level. Unfortunately, decreasing the clock frequency also decreases a maximum performance capability. However, if utilization or a desired level of performance increases, the clock frequency can be again increased to offset the performance loss at the lower voltage and frequency levels. Thus, a tradeoff between processing performance and power consumption can be made over time by adjusting a clock frequency for power management purposes.

A specific power management example that includes frequency changes is described next. In some electronic devices, such as many smart phones, a video recorder or camcorder feature enables video images to be recorded and stored on the device. The electronic device typically processes the video images to improve visual quality, to compress the data for storage, and so forth. Manipulating the video image data is, however, a processing intensive operation that entails high power consumption. In one hypothetical, a video processing core of an integrated circuit is responsible for manipulating video image data at a rate of 400 megapixels per second (MPps). The integrated circuit offers two power management levels near this processing rate. These two power management levels enable video image data to be processed at 300 or 500 MPps, with the latter consuming more power. Operating at 300 MPps will fail to achieve the desired performance. The video processing core can operate at 500 MPps to meet the desired performance, but at a cost of wasted power consumption. Alternatively, the desired performance can be met and power can be conserved by dynamically switching between the performance levels of 300 and 500 MPps so as to average at least 400 MPps (e.g., by switching between 300 and 500 MPps at a 50/50 duty cycle). Thus, to achieve a measure of power conservation while still meeting processing demands, the integrated circuit can implement dynamic frequency scaling to switch between the two performance levels for the video processing core.

On a typical integrated circuit, a phase-locked loop (PLL) is used to generate voltage levels that oscillate at regular intervals to produce a clock signal. The rate of oscillation is referred to as a frequency for the clock signal. Many PLLs can change the oscillation frequency in a smooth manner that permits continuous circuit operation during the frequency change. However, PLL circuits occupy a relatively large area on an integrated circuit chip, so each core on an chip is usually not provided with a unique PLL circuit for each core's respective clock signal. Instead, one or a few PLL circuits are often shared with numerous different cores, with each core to be operated at an individual or separate clock frequency. To produce numerous different clock frequencies for numerous individual core clock signals using just one or a few PLL circuits, the integrated circuit chip typically applies at least one clock divider to a baseline clock signal generated by the PLL circuit.

Unfortunately, adjusting a clock frequency with a clock divider is not a fast and smooth operation. If processing logic of a core continues to process data during a frequency-adjustment operation that is performed using a clock divider, data can be corrupted within the processing logic. To reduce the risk of data corruption, the clock signal is gated, or prevented from reaching the processing logic of the core. After the frequency-adjustment operation is completed, the clock signal with the adjusted frequency can be permitted to propagate to the processing logic so that data processing can resume. Regrettably, this creates another problem—the data processing resumption in one core can cause data corruption in other cores. This problem is explained next in the context of a shared power rail.

With some integrated circuit chips, multiple cores are coupled to and powered by a shared power rail. A power management integrated circuit (PMIC) holds the power rail at some voltage level to provide a supply voltage. To ensure that cores operate reliably, the PMIC is responsible for maintaining the supply voltage within some prescribed voltage range. If the supply voltage drops below this prescribed voltage range, reliable data processing within the cores is jeopardized, and data is eventually corrupted. The PMIC is generally capable of maintaining a stable supply voltage over wide ranges of current draws. However, in some situations, the PMIC may fail to keep the supply voltage above a lower threshold level of a prescribed voltage range. For example, if a core increases a current drain too quickly, then the PMIC may be unable to maintain the supply voltage at a safe, reliable level.

During operation, each core pulls current from the shared power rail. A given core pulls more current from the shared power rail if the corresponding core clock signal is oscillating as compared to if the core clock signal is gated. Thus, while a core clock signal is gated for a particular core, that particular core is drawing significantly less current because transistor switching and other energy-using operations are paused. After the core clock signal is restarted for the core and the processing logic is reactivated, the core suddenly begins to draw current again. Many of the paused transistors are again switching on-and-off in accordance with the oscillations of the adjusted frequency of the core clock signal. Consequently, the current draw from the shared power rail to the particular core increases quickly. This sudden current drain, due to the high rate of change of the current flow, causes the voltage level on the shared power rail to temporarily drop, or droop. The voltage droop causes other cores that are also coupled to the shared power rail to function incorrectly. Thus, reactivating processing logic in one core with a restarted clock after a frequency-adjustment operation can cause other cores to malfunction.

To ameliorate this risk, in one or more example implementations, a core is separated into multiple partitions, and clock control circuitry sequentially reactivates the multiple partitions after a frequency-adjustment operation of a core clock signal. An integrated circuit includes a clock source, a clock-signal controller, and the core. The core includes the multiple partitions and the clock control circuitry. The clock control circuitry includes clock stagger circuitry and clock gating circuitry. The clock source generates the core clock signal that oscillates at a core frequency. The clock source provides the core clock signal to the core. Each partition operates responsive to oscillation of the core clock signal.

To facilitate a safe and reliable frequency-adjustment operation, the clock-signal controller generates a clock adjustment indicator signal that is indicative of the frequency-adjustment operation. Based on an asserted clock adjustment indicator signal from the clock-signal controller, the clock gating circuitry gates the core clock signal to prevent oscillations from reaching the multiple partitions. The clock source performs the frequency-adjustment operation to adjust (e.g., increase or decrease) the core frequency of the core clock signal. Oscillations of the core clock signal at the adjusted core frequency are then routed to the clock gating circuitry of the core.

For the core, the clock gating circuitry creates multiple versions of the core clock signal based on oscillations of the core clock signal. Respective versions of the multiple versions of the core clock signal are routed to respective partitions of the multiple partitions of the core. Generally, oscillation of the multiple versions of the core clock signal are sequentially released (e.g., released in a staggered fashion) such that the multiple partitions are reactivated sequentially (e.g., not simultaneously). To do so, the clock-signal controller de-asserts the clock adjustment indicator signal after the clock source performs the frequency-adjustment operation. Responsive to the de-assertion of the clock adjustment indicator signal, the clock stagger circuitry provides multiple clock enable signals.

The clock stagger circuitry includes multiple delay units to implement multiple delay periods. After expiration of each delay period, the clock stagger circuitry asserts a clock enable signal. Thus, the clock stagger circuitry provides the multiple clock enable signals to the clock gating circuitry at staggered, different times. Responsive to receipt of a respective asserted clock enable signal, the clock gating circuitry releases a respective version of the multiple versions of the core clock signal. Oscillation of the multiple versions of the core clock signal, which are coupled to respective ones of the multiple partitions, are therefore restarted in a staggered, sequential fashion. As a result, the clock control circuitry causes the multiple partitions to be sequentially reactivated after the frequency-adjustment operation.

In these manners, example implementations that are described herein stagger the reintroduction of an oscillating core clock signal to a core after a clock frequency adjustment. Different partitions of the core are reactivated with an oscillating version of the core clock signal at different times. This staggering of the reactivation of the processing logic of the core enables the restarting of the current flow to occur at a gradual rate, or at least at a stair-stepped incremental rate. Consequently, the rate of change of the current drawn by the core from the shared power rail is managed at a reduced level. Accordingly, voltage droop on the shared power rail can be avoided or at least reduced, and other cores that are coupled to the shared power rail can continue to operate reliably while frequency-adjustment operations are performed for individual cores.

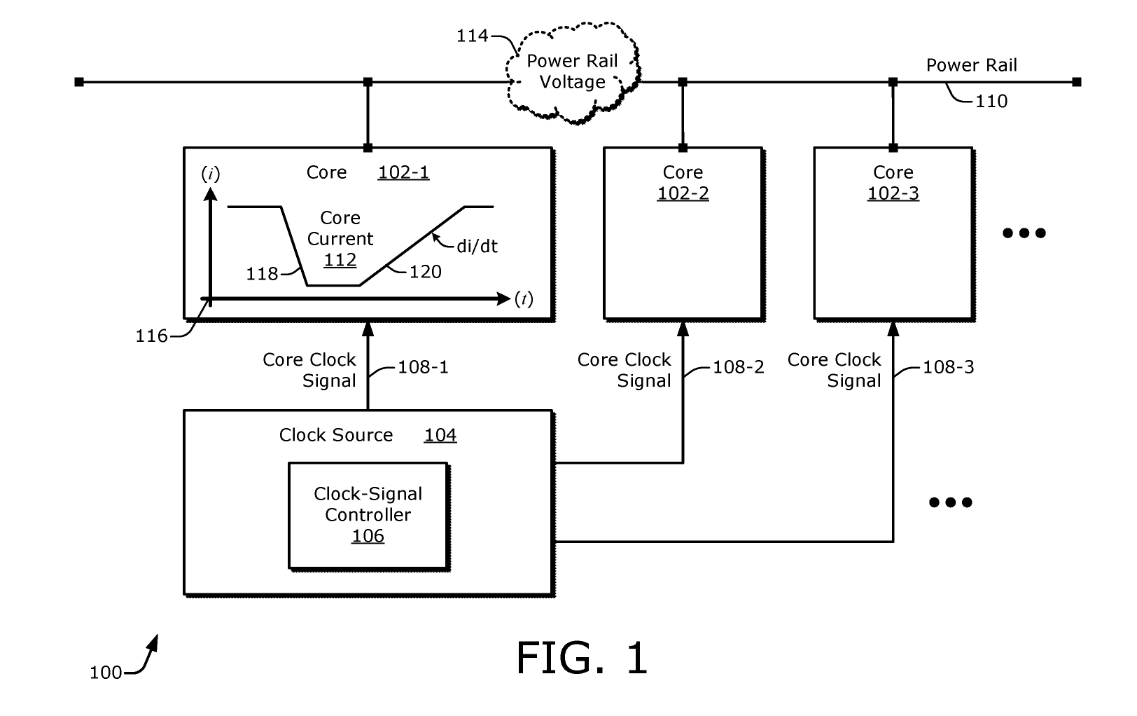

FIG. 1 illustrates a portion of an example integrated circuit 100 that includes a power rail 110 that is coupled to multiple cores 102-1 to 102-3 in which clock signal staggering with clock frequency adjustment can be implemented in conjunction with a clock source 104 and a clock-signal controller 106. As shown, the integrated circuit 100 includes a power rail 110 that provides a power rail voltage 114. Thus, the multiple cores 102-1, 102-2, and 102-3 share the power rail 110. Although three cores 102-1, 102-2, and 102-3 are explicitly depicted, more or fewer cores can be coupled to the power rail 110. In operation, a power management integrated circuit (PMIC) (not shown) holds the power rail 110 at the power rail voltage 114. A voltage level of the power rail voltage 114 should remain sufficiently high to enable the multiple cores 102-1 to 102-3 to perform processing operations (e.g., logical operations, instruction handling, or data transfer or storage operations) without error. The description of FIG. 1 continues with a focus on the core 102-1, but the described principles are also applicable to other cores.

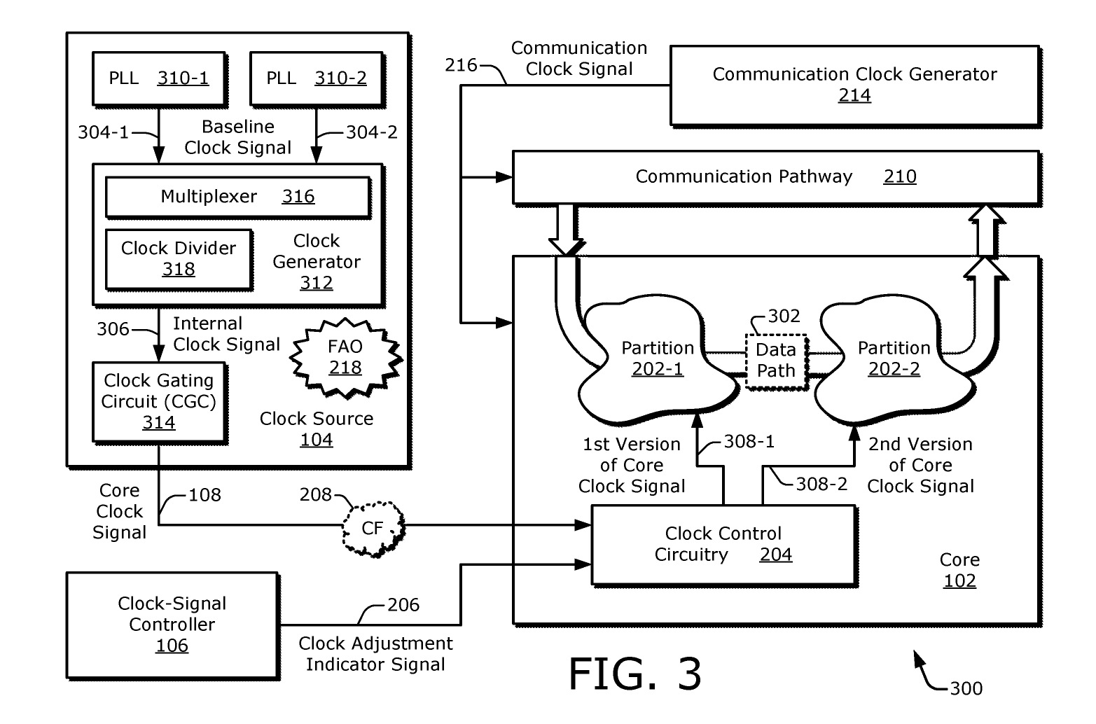

As illustrated, the clock source 104 provides multiple core clock signals 108-1, 108-2, and 108-3 to respective cores 102-1, 102-2, and 102-3. Although three core clock signals 108-1, 108-2, and 108-3 are explicitly depicted, the clock source 104 can generate more or fewer core clock signals. The core 102-1 operates based on oscillation of the core clock signal 108-1, such as rising or falling edges of pulses of the core clock signal 108-1. As explained above, the core 102-1 typically processes data more quickly at higher clock frequencies, but the core 102-1 also uses more power at the higher clock frequencies. Consequently, the clock source 104 adjusts a frequency of the core clock signal 108-1 up or down to accommodate contemporaneous processing demands. As is explained further with reference to FIG. 3, the clock source 104 typically stops oscillations of the core clock signal 108-1 from reaching the core 102-1 during a frequency-adjustment operation to prevent errors from occurring in the data processing of the core 102-1. After the frequency-adjustment operation, the oscillations of the core clock signal 108-1 are again permitted to propagate to the core 102-1.

A level of core current 112 that is flowing within the core 102-1 as a result of the frequency-adjustment operation is graphically depicted. A graph 116 includes a horizontal axis representing time (t) and a vertical axis representing current (i). The upper-left horizontal portion of the core current 112 represents a steady-state condition of a regular processing phase. The descending slope 118 represents a period in which the flow of the core current 112 is rapidly decreasing because the oscillation of the core clock signal 108-1 has been gated from reaching the core 102-1. The clock source 104 or clock-gating circuitry that is internal to the core 102-1, for example, can perform the gating of the core clock signal 108-1. The lower horizontal portion of the core current 112 represents a steady-state condition for a frequency adjustment phase (e.g., during a frequency-adjustment operation) when oscillations of the core clock signal 108-1 are not applied to processing circuitry (not shown in FIG. 1) of the core 102-1. After the frequency-adjustment operation, the clock source 104, or the clock-gating circuitry that is internal to the core 102-1, releases the core clock signal 108-1 to permit the oscillations thereof to reach the processing circuitry of the core 102-1.

The ascending slope 120 represents a period in which the flow of the core current 112 is increasing at some rate as the processing circuitry of the core 102-1 is reactivated. Eventually, as represented at the upper-right horizontal portion of the graph 116, the core current 112 returns to the steady-state condition of the regular processing phase. For the ascending slope 120, the rate of increase of the flow of the core current 112 can be algebraically represented as the derivative of the current with respect to time, or “di/dt.” The size or speed of this rate of increase can create problems in the integrated circuit 100. For example, if the flow of the core current 112 in the core 102-1 increases too quickly (e.g., if the ascending slope 120 is too steep), the stability of the power rail 110 can be affected.

As the flow of the core current 112 increases, the core 102-1 pulls more current from the power rail 110. If the amount of current pulled from the power rail 110 increases faster than can be compensated for by the PMIC, the voltage level of the power rail voltage 114 temporarily drops, which is referred to as a voltage droop on the power rail 110. During the voltage droop, correct data processing in the other cores, such as the core 102-2, is jeopardized. Thus, if the rate of increase of the core current 112 in the core 102-1 is too great along the ascending slope 120, a voltage droop develops on the power rail 110 that can cause errors in the other cores. To reduce the risk of computational errors being created from voltage droops, the steepness of the ascending slop 120 can be decreased by decreasing the rate of increase of the flow of the core current 112. As described herein, the rate of increase of the flow of the core current 112 is managed after a frequency-adjustment operation by gradually reintroducing oscillations of the core clock signal 108-1 to different partitions of the core 102-1 at different, staggered times.

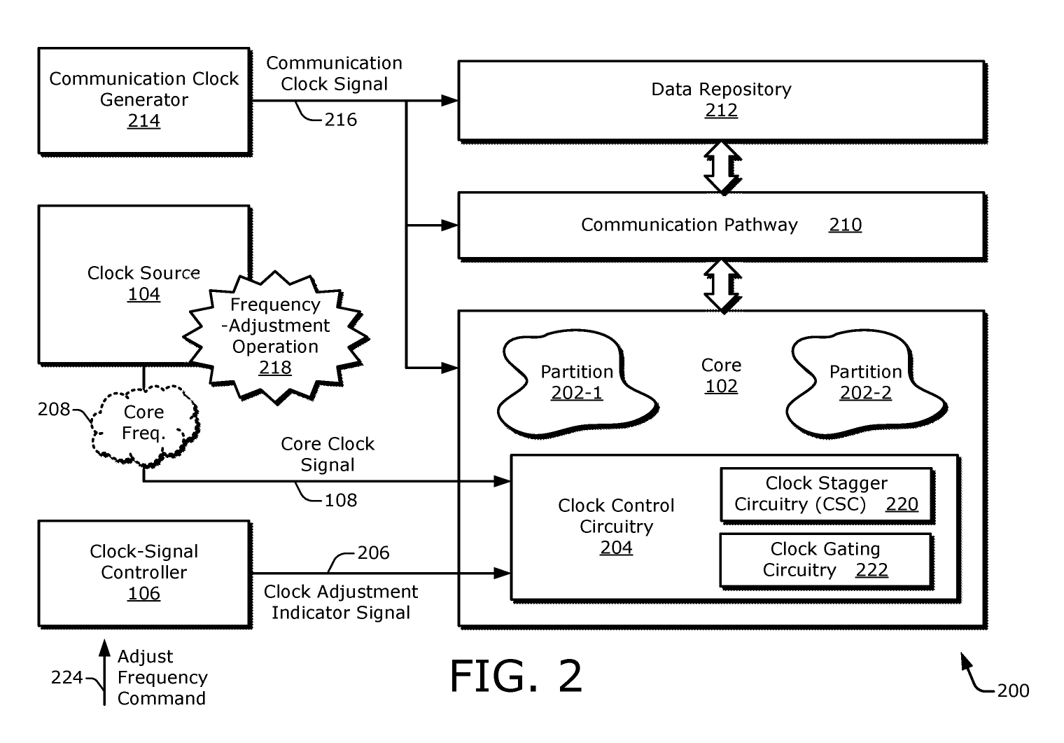

FIG. 2 illustrates an example integrated circuit portion 200 that includes a core 102, the clock source 104, and the clock-signal controller 106. As shown, the integrated circuit portion 200 also includes a communication pathway 210, a data repository 212, and a communication clock generator 214. The core 102 includes multiple partitions 202-1 and 202-2 and clock control circuitry 204. The clock control circuitry 204 includes clock stagger circuitry 220 (CSC) and clock gating circuitry 222. Each partition 202 performs some data processing for the core 102. Although two partitions 202-1 and 202-2 are explicitly depicted, the core 102 can be separated into more or fewer partitions. In example implementations generally, the clock-signal controller 106 generates a clock adjustment indicator signal 206 and provides the clock adjustment indicator signal 206 to the clock control circuitry 204. The clock adjustment indicator signal 206 is indicative of an occurrence of a frequency-adjustment operation 218.

In a regular processing phase, the clock source 104 generates the core clock signal 108 that is oscillating at a core frequency 208. The clock source 104 provides the core clock signal 108 to the core 102. The core 102 operates based on the core clock signal 108. Thus, a processing speed of the core 102 depends at least partially on the core frequency 208 of the core clock signal 108. The core 102 and the data repository 212 are coupled to the communication pathway 210. The core 102, the communication pathway 210, and the data repository 212 are coupled to the communication clock generator 214. The communication clock generator 214 generates a communication clock signal 216 and provides the communication clock signal 216 to the data repository 212, the communication pathway 210, and the core 102. Thus, data can be transferred between the core 102 and the data repository 212 via the communication pathway 210 based on the communication clock signal 216.

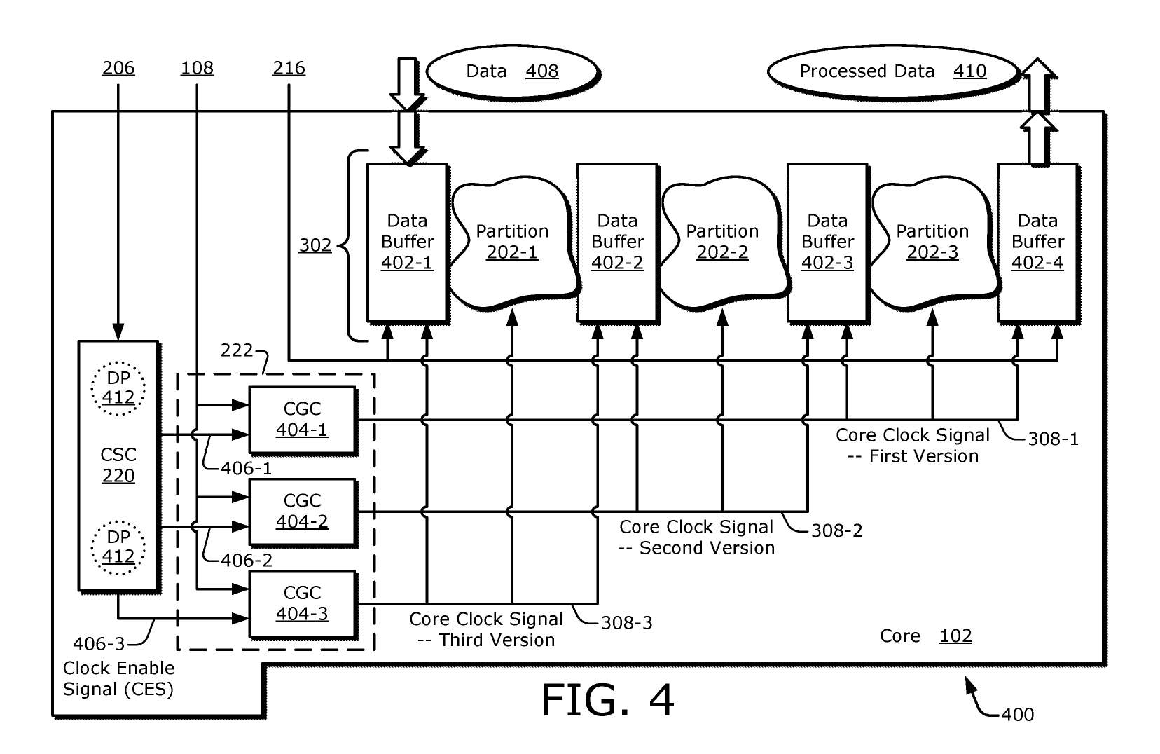

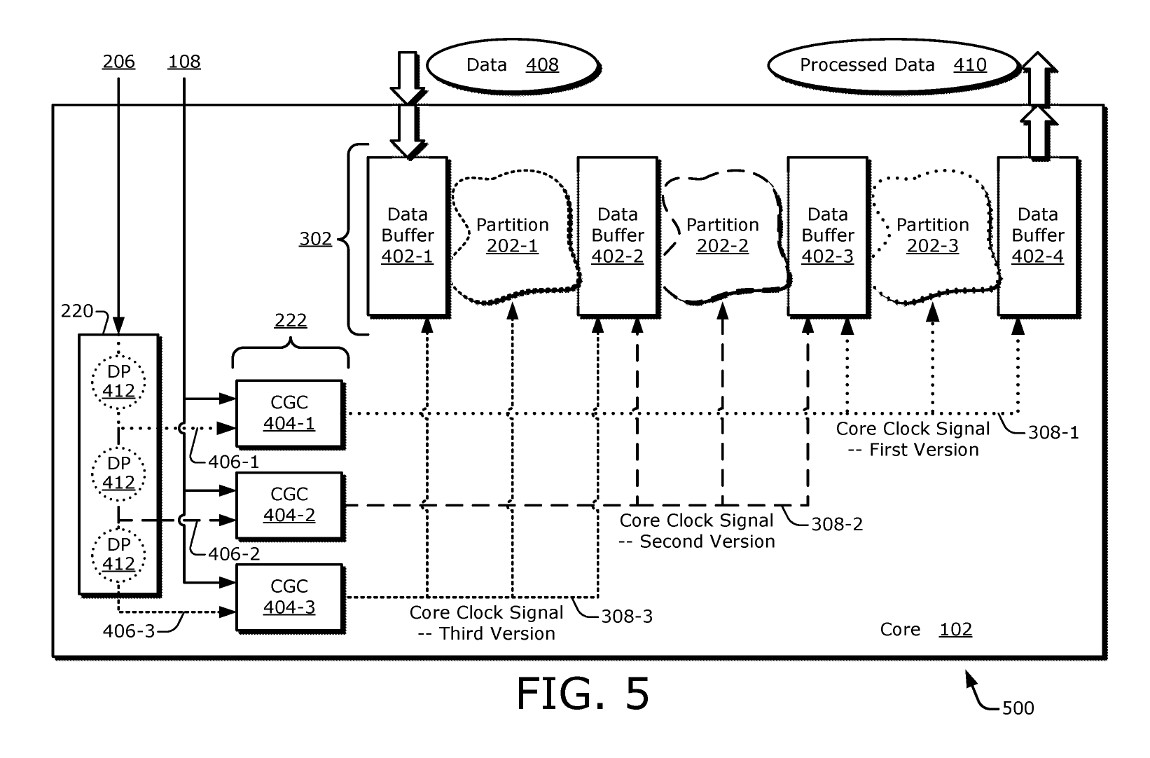

In operation, the core 102 receives data via the communication pathway 210, processes the data, and provides the processed data via the communication pathway 210. The communication pathway 210 can be implemented as a bus, a switching fabric, a network-on-chip (NOC), a memory bus, a processor local bus, some combination thereof, and so forth. The data repository 212 represents on-chip data storage (e.g., memory), another core (not shown in FIG. 2), an interface for remotely-located data (e.g., a modem), off-chip memory such as Double Data Rate (DDR) SRAM, and so forth. The data repository 212 thus represents a source or sink for data. The core 102 can therefore receive data from the communication pathway 210 and provide processed data to the communication pathway 210 responsive to pulses of the communication clock signal 216. Interaction between the communication clock signal 216 and the multiple partitions 202-1 and 202-2 is described below with reference to FIGS. 4 and 5.

In some implementations, the clock-signal controller 106 asserts the clock adjustment indicator signal 206 based on an adjust frequency command 224. Further, the clock source 104 performs the frequency-adjustment operation 218 responsive to the adjust frequency command 224. The adjust frequency command 224 can be provided from any of multiple potential entities. For example, software that wants a higher level of performance can set a register value that serves as the adjust frequency command 224. For instance, in a multimedia environment, an application that is processing video image data can set the register to adjust the clock frequency at a frame boundary of a video. Additionally or alternatively, hardware can determine to adjust the clock frequency and then assert a line corresponding to the adjust frequency command 224. For instance, a utilization management module can increase the clock frequency if the core 102 is nearing full utilization and reduce the clock frequency if the core is less than half utilized.

As described above, the core frequency 208 of the core clock signal 108 is changed from time-to-time to accommodate varying processing demands on the core 102 based on the adjust frequency command 224. Accordingly, the clock source 104 performs the frequency-adjustment operation 218 to adjust the core frequency 208 of the core clock signal 108. To enable the core 102 to gradually reactivate data processing in a staggered manner across the multiple partitions 202-1 to 202-2 after the frequency-adjustment operation 218, the clock-signal controller 106 asserts the clock adjustment indicator signal 206 to indicate that the frequency-adjustment operation 218 is to occur. Thus, the clock-signal controller 106 is responsible for asserting the clock adjustment indicator signal 206 at least while the clock source 104 adjusts the core frequency 208 of the core clock signal 108 and for de-asserting the clock adjustment indicator signal 206 after the core frequency 208 is adjusted. Example implementations for pausing and reactivating the data processing of the core 102, including operation of the clock stagger circuitry 220 and the clock gating circuitry 222, are described below with reference to FIG. 4 and succeeding figures. First, however, an example scheme for adjusting the core frequency 208 is described with reference to FIG. 3.

FIG. 3 illustrates an example scheme 300 for how the clock source 104 can adjust the core frequency 208 (CF) of the core clock signal 108 and how the clock control circuitry 204 can handle the frequency-adjustment operation 218 based on the clock adjustment indicator signal 206. The clock source 104 includes multiple phase-locked loops 310-1 (PLLs), 310-2 . . . ; a clock generator 312; and a clock gating circuit 314 (CGC). The clock generator 312 includes a multiplexer 316 and a clock divider 318. Although two PLLs 310-1 and 310-2 are explicitly depicted, the clock source 104 can alternatively include more or fewer PLLs. Further, although the clock-signal controller 106 is depicted separately from the clock source 104, the clock source 104 may alternatively incorporate the clock-signal controller 106 as shown in FIG. 1.

Each respective PLL 310-1 and 310-2 generates a respective baseline clock signal 304-1 and 304-2 having a baseline frequency. An individual PLL 310 can be provided for each respective core 102 of multiple cores 102-1 to 102-3 (of FIG. 1). However, each PLL circuit occupies a significant area of an integrated circuit chip. Consequently, a reduced number of PLLs are typically included as part of the clock source 104. The clock generator 312 is thus employed to produce a variety of different clock frequencies for multiple core clock signals 108-1 to 108-3 (of FIG. 1) that can be individually coupled to each of the multiple cores 102-1 to 102-3.

To implement the frequency-adjustment operation 218, the clock generator 312 receives at least one baseline clock signal 304 from at least one PLL 310. Generally, the clock generator 312 generates an internal clock signal 306 at an adjustable frequency using the baseline clock signal 304. More specifically, the multiplexer 316 selectively routes one or more of the multiple baseline clock signals 304-1 to 304-2 to at least one clock divider 318. The clock divider 318 uses the baseline clock signal 304 to produce the internal clock signal 306. For example, the clock divider 318 can alter the baseline frequency of the baseline clock signal 304 by an integer or a half-integer to increase or decrease the rate of oscillation to produce a new, different frequency for the internal clock signal 306. Alternatively, other fractional clock cycles can be used on the baseline clock signal 304 instead of integer and half-integers to generate the internal clock signal 306.

During the frequency-adjustment operation 218, the clock gating circuit 314 can gate the internal clock signal 306 to prevent changes to the voltage level of the core clock signal 108. Accordingly, after the frequency-adjustment operation 218, the clock gating circuit 314 releases the internal clock signal 306 so that the oscillations thereof can propagate to the core 102 as the core clock signal 108. To prevent the sudden restarting of the core clock signal 108 from causing current levels within the core 102 to increase at a rate that produces a harmful voltage droop on the power rail 110 (of FIG. 1), the clock control circuitry 204 gradually reintroduces the core clock signal 108 using multiple versions of the core clock signal 308-1 and 308-2. Although two versions of the core clock signal 308-1 and 308-2 are explicitly depicted in FIG. 3, the clock control circuitry 204 can alternatively generate more than two versions.

To enable the clock control circuitry 204 to manage the restarting of the core clock signal 108, the clock-signal controller 106 provides a hint about the frequency-adjustment operation 218. Specifically, the clock-signal controller 106 provides the clock adjustment indicator signal 206 to the clock control circuitry 204 of the core 102. For example, the clock-signal controller 106 can assert the clock adjustment indicator signal 206 before the frequency-adjustment operation 218 begins and continue the assertion during performance of the frequency-adjustment operation 218. In some implementations, the clock-signal controller 106 asserts the clock adjustment indicator signal 206 just before the frequency-adjustment operation 218 begins (e.g., in response to an asserted adjust frequency command 224 of FIG. 2) and de-asserts the clock adjustment indicator signal 206 after the frequency-adjustment operation 218 is completed.

Within the core 102, the multiple partitions 202-1 and 202-2 are arranged into a data path 302. During the regular processing phase, data is moved along the data path 302 based on the core frequency 208 of the core clock signal 108. To do so, a respective version of the core clock signal 308 is supplied to each respective partition 202. The clock control circuitry 204 generates a first version of the core clock signal 308-1 and a second version of the core clock signal 308-2 using the core clock signal 108. The clock control circuitry 204 provides the first version of the core clock signal 308-1 to the first partition 202-1 and the second version of the core clock signal 308-2 to the second partition 202-2. Thus, during a regular processing phase, oscillations of the core clock signal 108 are passed on to the multiple partitions 202-1 to 202-2 using the multiple versions of the core clock signal 308-1 to 308-2. In contrast, during the frequency-adjustment operation 218, the clock gating circuit 314 or the clock control circuitry 204 gates the core clock signal 108. Thus, oscillations of the core clock signal 108 are not propagated by the respective first and second versions of the core clock signal 308-1 and 308-2 to the respective partitions 202-1 and 202-2 during the frequency-adjustment operation 218.

After the frequency-adjustment operation 218 is completed, the clock control circuitry 204 staggers the release of the multiple versions of the core clock signal 308-1 and 308-2 based on the clock adjustment indicator signal 206 such that oscillations of the different versions are restarted at different times. The clock control circuitry 204 implements at least one delay period so as to restart the multiple versions of the core clock signal 308-1 to 308-2 sequentially, as opposed to simultaneously. Thus, the clock control circuitry 204 can reactivate the partitions at different times responsive to a de-assertion of the clock adjustment indicator signal 206 by the clock-signal controller 106. For example, in some implementations, the clock control circuitry 204 initially releases oscillations on the second version of the core clock signal 308-2 to reactivate the second partition 202-2. Subsequently, after at least one delay period, the clock control circuitry 204 releases oscillations on the first version of the core clock signal 308-1 to reactivate the first partition 202-1. However, the order of the staggered restarting of the different versions of the core clock signal 308-2 and 308-1 can be different.

FIG. 4 illustrates an example approach 400 for the production and manipulation of multiple versions of the core clock signal 308-1 to 308-3 that are routed within the core 102 to handle a restart of the core clock signal 108 after a frequency-adjustment operation 218 (e.g., of FIG. 3). As illustrated, the core 102 includes multiple partitions 202-1 to 202-3 and multiple data buffers 402-1 to 402-4. Specifically, three partitions 202-1, 202-2, and 202-3 and four data buffers 402-1, 402-2, 402-3, and 402-4 are depicted. However, a core can include more or fewer partitions or data buffers.

With reference also to FIG. 2, the clock control circuitry 204 includes clock stagger circuitry 220 (CSC) and clock gating circuitry 222. The clock stagger circuitry 220 and the clock gating circuitry 222 are individually illustrated in FIG. 4. Further, the clock gating circuitry 222 is shown to include multiple clock gating circuits 404-1 to 404-3 (CGC). Specifically, the clock gating circuitry 222 includes three clock gating circuits 404-1, 404-2, and 404-3, but more or fewer clock gating circuits may be employed as part of the clock gating circuitry 222.

In example implementations, the multiple partitions 202-1 to 202-3, in conjunction with the multiple data buffers 402-1 to 402-4, form a data path 302. In operation, one or more of the data buffers 402-1 to 402-4 are responsible for buffering data between consecutive partitions of the multiple partitions 202-1 to 202-3 or between a partition 202 and the communication pathway 210 (e.g., of FIGS. 2 and 3). Thus, data is propagated along the data path 302 between consecutive partitions via a given data buffer 402. For example, data can be transferred from the partition 202-1 to the partition 202-2 via the data buffer 402-2. At each partition 202, the data can be modified as part of a data processing operation. If so, the data path 302 corresponds to a data processing pipeline between the first partition 202-1 and the third partition 202-3. At the beginning of the data processing pipeline, data 408 is provided from the communication pathway 210 to the data path 302 via the data buffer 402-1. The data processing pipeline transforms the data 408 into processed data 410. After processing, the processed data 410 is provided from the data buffer 402-4 of the data processing pipeline to the communication pathway 210. The data processing pipeline can implement, for instance, processing of media data that represents video images captured by a camera for storage or display on a screen.

To propagate data along the data path 302, clock signals are provided to the multiple data buffers 402-1 to 402-4. Each data buffer 402 can operate as a multi-clock data buffer in which data is transferred across the data buffer based on oscillation of at least two different clock signals. A given data buffer, such as the data buffer 402-3, advances data from one partition 202-2 to a consecutive partition 202-3 responsive to, for instance, an edge of a clock pulse arriving at the given data buffer 402-3 from two different clock signals (e.g., the second version of the core clock signal 308-2 and the first version of the core clock signal 308-1). A multi-clock data buffer can be implemented as, for example, an asynchronous dual-clock first in, first out (FIFO) buffer.

To interface with the communication pathway 210, the communication clock signal 216 is coupled to the first data buffer and the last data buffer of the data path 302, e.g., the data buffers 402-1 and 402-4, respectively. To advance data within the core 102, at least one version of the core clock signal 308 is coupled to each data buffer. Specifically, the third version of the core clock signal 308-3 is coupled to the data buffer 402-1 and the data buffer 402-2, the second version of the core clock signal 308-2 is coupled to the data buffer 402-2 and the data buffer 402-3, and the first version of the core clock signal 308-1 is coupled to the data buffer 402-3 and the data buffer 402-4. Additionally, the first, second, and third versions of the core clock signal 308-1, 308-2, and 308-3 are respectively coupled to the partitions 202-3, 202-2, and 202-1.

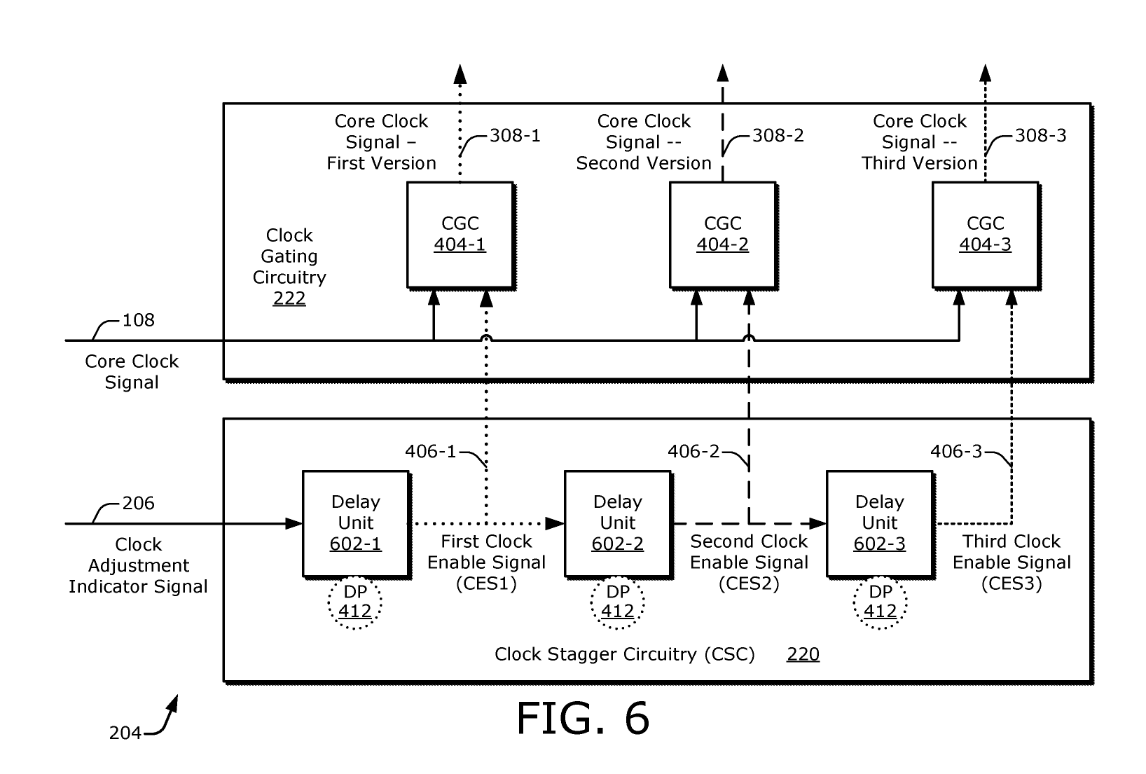

As shown, starting at the top left corner of FIG. 4, the clock adjustment indicator signal 206 is coupled to the clock stagger circuitry 220. The clock stagger circuitry 220 generates multiple clock enable signals 406-1 to 406-3 (CES) based on the clock adjustment indicator signal 206 using at least one delay period 412 (DP). Generally, the clock stagger circuitry 220 produces the multiple clock enable signals 406-1 to 406-3 so as to be delayed with respect to each other based on the clock adjustment indicator signal 206. Although three clock enable signals 406-1, 406-2, and 406-3 are explicitly shown and described herein, more or fewer may alternatively be implemented (e.g., depending on how many clock gating circuits or partitions are included in the core 102). Example realizations for the clock stagger circuitry 220 are described below with reference to FIGS. 6-8, including descriptions of example techniques for implementing a delay period 412. The clock stagger circuitry 220 provides the multiple clock enable signals 406-1 to 406-3 to the clock gating circuitry 222.

The core clock signal 108 is coupled to the clock gating circuitry 222. As illustrated, the core clock signal 108 is coupled to each of the multiple clock gating circuits 404-1 to 404-3. Each respective clock gating circuit 404-1, 404-2, and 404-3 receives a respective clock enable signal 406-1, 406-2, and 406-3. Each respective clock gating circuit 404-1, 404-2, and 404-3 respectively provides the first, second, and third version of the core clock signal 308-1, 308-2, and 308-3. Thus, each respective clock gating circuit 404 generates a respective version of the core clock signal 308 based on the core clock signal 108 and a respective clock enable signal 406.

In example implementations generally, each partition 202 operates based on oscillation of a respective version of the core clock signal 308. Thus, the partition 202-1 operates responsive to pulses of the third version of the core clock signal 308-3, and the partition 202-2 operates responsive to pulses of the second version of the core clock signal 308-2. And the partition 202-3 operates responsive to pulses of the first version of the core clock signal 308-1.

Each data buffer 402 propagates data based on oscillation of two clock signals. For example, the data buffer 402-1 propagates data based on the oscillation of the communication clock signal 216 and the third version of the core clock signal 308-3. Thus, the data buffer 402-1 accepts the data 408 from the communication pathway 210 responsive to an edge of a pulse of the communication clock signal 216. The data buffer 402-1 also forwards data to the partition 202-1 responsive to an edge of a pulse of the third version of the core clock signal 308-3. Data buffers that are coupled between consecutive partitions operate similarly. For example, the data buffer 402-2 passes data from the partition 202-1 to the partition 202-2 responsive to the rising or falling edges of pulses of the third version of the core clock signal 308-3 and the second version of the core clock signal 308-2.

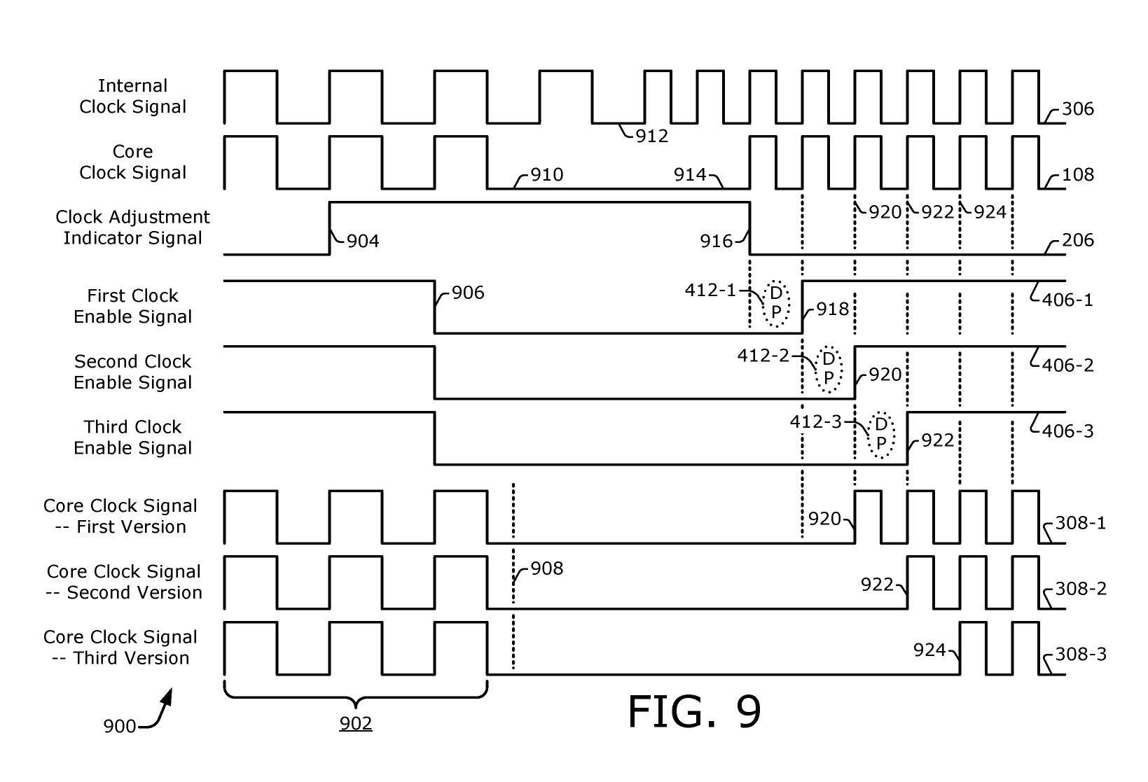

In operation generally, the clock gating circuitry 222 can pass the pulses of the core clock signal 108 or can gate them to prevent the pulses from propagating into the core 102 based on a state of at least one clock enable signal 406—e.g., an asserted state or a non-asserted state—that is provided by the clock stagger circuitry 220. The clock stagger circuitry 220 asserts or de-asserts a clock enable signal 406 based on a state of the clock adjustment indicator signal 206. More specifically, in example implementations, each respective clock gating circuit 404 gates a respective version of the core clock signal 308 responsive to a state of a respective clock enable signal 406. For instance, the clock gating circuit 404-1 gates the core clock signal 108 or passes the core clock signal 108 as the first version of the core clock signal 308-1 responsive to the state of the clock enable signal 406-1. An example order for the gating operations is described below with reference to FIG. 5. Example signal timings are described further below with reference to a signal timing diagram of FIG. 9.

FIG. 5 illustrates an example sequential release 500 of the multiple versions of the core clock signal 308-1 to 308-3 so that multiple partitions 202-1 to 202-3 can be reactivated at different times. As used herein, the term “sequential” refers to a process that occurs or to multiple actions that occur in a staggered order and therefore do not occur simultaneously. For instance, the start of one action intentionally precedes the start of another action, even if there is some overlap in the performance of extended actions. In an example implementation, the multiple partitions 202-1 to 202-3 are reactivated in the following order, from first to last: partition 202-3 (as represented by dotted lines), partition 202-2 (as represented by long-dashed lines), and partition 202-1 (as represented by short-dashed lines).

Initially, the clock-signal controller 106 (e.g., of FIG. 3) asserts the clock adjustment indicator signal 206 to indicate that a frequency-adjustment operation 218 is to be performed. In response, the clock stagger circuitry 220 de-asserts the multiple clock enable signals 406-1 to 406-3 to cause the multiple clock gating circuits 404-1 to 404-3 to gate the oscillations of the core clock signal 108. After the frequency-adjustment operation 218 is concluded, the clock-signal controller 106 de-asserts the clock adjustment indicator signal 206. Based on the de-assertion, the clock stagger circuitry 220 implements one or more delay periods 412.

For example, after one delay period 412 elapses, the clock stagger circuitry 220 asserts the clock enable signal 406-1 for the clock gating circuit 404-1. The clock gating circuit 404-1 therefore ceases gating the core clock signal 108 and permits the oscillations of the core clock signal 108 to be propagated as the first version of the core clock signal 308-1. The partition 202-3 starts to operate responsive to a first pulse on the first version of the core clock signal 308-1 (as represented by the dotted lines). Meanwhile, the clock stagger circuitry 220 implements another delay period 412. After this second delay period 412, the clock stagger circuitry 220 asserts the clock enable signal 406-2 for the clock gating circuit 404-2. The clock gating circuit 404-2 therefore ceases gating the core clock signal 108 and permits the oscillations of the core clock signal 108 to be propagated as the second version of the core clock signal 308-2. The partition 202-2 starts to operate responsive to a first pulse on the second version of the core clock signal 308-2 (as represented by the long-dashed lines). Similarly, after yet another delay period 412 elapses, the clock stagger circuitry 220 asserts the clock enable signal 406-3 provided to the clock gating circuit 404-3. The clock gating circuit 404-3 therefore ceases gating the core clock signal 108 and permits the oscillations of the core clock signal 108 to be propagated as the third version of the core clock signal 308-3. The partition 202-1 starts to operate responsive to a first pulse on the third version of the core clock signal 308-3 (as represented by the short-dashed lines).

In the example sequential order described above, the partitions are reactivated in the following staggered order: partition 202-3, partition 202-2, and partition 202-1. With this sequential order, which starts at the right-most, “end” of the data path 302 and finishes at the left-most, “beginning” of the data path 302, data propagation or processing can be expedited by continuing to transfer the processed data 410 to the communication pathway 210 (e.g., of FIGS. 2 and 3) as soon as one version of the core clock signal 308 is restarted. Further, each data buffer 402 can be as small as one storage element. However, other sequential orders can be implemented. For example, the partitions can be reactivated in the following opposite staggered order (e.g., starting at the left-most, “beginning” of the data path 302 and finishing at the right-most, “end” of the data path 302): partition 202-1, partition 202-2, and partition 202-3. In other alternative sequential orders, the order can deviate from the consecutive order of the data path 302 as laid out structurally or logically on the core 102. For instance, the partitions can be reactivated in the following staggered order: partition 202-2, partition 202-1, and partition 202-3.

FIG. 6 illustrates an example of clock control circuitry 204 that includes clock gating circuitry 222 and clock stagger circuitry 220. The clock control circuitry 204 illustrated in FIG. 6 is an enlarged view of the clock gating circuitry 222 and the clock stagger circuitry 220 as shown in FIGS. 4 and 5. Additionally, the clock stagger circuitry 220 includes multiple delay units 602-1 to 602-3 along with one or more associated delay periods 412. Although three delay units 602-1, 602-2, and 602-3 and associated delay periods are explicitly shown, more or fewer delay units may alternatively be implemented.

In example implementations, the multiple delay units 602-1 to 602-3 are coupled together in a chained series. Each respective delay unit 602 implements or creates at least one respective delay period 412. Thus, one or more delay units 602-1 to 602-3 are responsible for delaying propagation of the oscillations of the core clock signal 108. To do so, the delay unit 602-1 receives the clock adjustment indicator signal 206. The delay unit 602-1 generates the first clock enable signal 406-1 (CES1) and provides the first clock enable signal 406-1 to the delay unit 602-2 and the clock gating circuit 404-1. The delay unit 602-2 generates the second clock enable signal 406-2 (CES2) and provides the second clock enable signal 406-2 to the delay unit 602-3 and the clock gating circuit 404-2. The delay unit 602-3 generates the third clock enable signal 406-3 (CES3) and provides the third clock enable signal 406-3 to the clock gating circuit 404-3.

To indicate that a frequency-adjustment operation 218 has been completed and that the multiple versions of the core clock signal 308-1 to 308-3 are to be restarted, the clock-signal controller 106 de-asserts the clock adjustment indicator signal 206. Responsive to the de-assertion, the delay unit 602-1 implements the associated delay period 412. After expiration of the delay period 412, the delay unit 602-1 outputs the first clock enable signal 406-1. The delay unit 602-1 can output the first clock enable signal 406-1 by, for instance, changing a state of the first clock enable signal 406-1 (e.g., changing a voltage level of the signal) to assert the first clock enable signal 406-1. Responsive to a state change of the first clock enable signal 406-1, the delay unit 602-2 implements another delay period 412. After expiration of this other delay period 412, the delay unit 602-2 outputs the second clock enable signal 406-2, such as by asserting the second clock enable signal 406-2. This propagation of the clock enable signals along the chain of multiple delay units continues until a final delay unit is reached. Thus, in the depicted example, the delay unit 602-3 produces the third clock enable signal 406-3 for the clock gating circuit 404-3.

Each delay period 412 can be implemented in any manner. For example, a delay period 412 can be generated independently of a periodic clock signal. Alternatively, a delay period 412 can be generated based on a periodic clock signal. Each delay period 412 can have a same duration or can have different durations. Further, multiple delay units can be jointly employed to produce a single delay period 412.

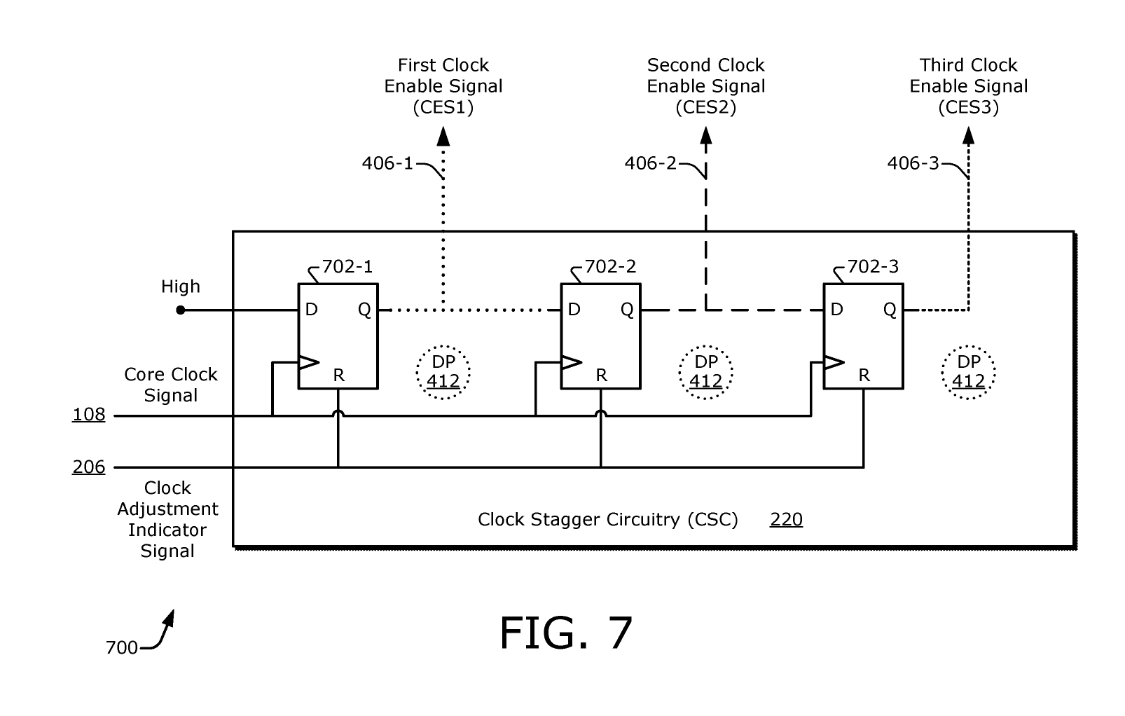

FIG. 7 illustrates generally at 700 an example of clock stagger circuitry 220 in which multiple delay units (e.g., the multiple delay units 602-1 to 602-3 of FIG. 6) are implemented using multiple flip-flops 702-1 to 702-3. As shown, three flip-flops 702-1, 702-2, and 702-3 are chained together in series. However, more or fewer than three flip-flops can alternatively be implemented. Each flip-flop 702 is shown and described as a “D” or “d-q” flip-flop; however, other flip-flop types may alternatively be implemented as part of the clock stagger circuitry 220. Generally, with a clock-signal-based mode of operation, an edge of a pulse produced by an oscillation of the core clock signal 108 triggers each flip-flop 702.

In some implementations, the clock stagger circuitry 220 receives the core clock signal 108 as well as the clock adjustment indicator signal 206. By receiving the core clock signal 108, the clock stagger circuitry 220 can implement one or more delay periods 412 that are based on a length of a clock cycle period, or clock cycle duration. Each flip-flop 702 includes a d-input, a q-output, a clocking input, and a reset input (R). The clock adjustment indicator signal 206 is coupled to the reset input (R) of each flip-flop 702. The core clock signal 108 is coupled to the clocking input of each flip-flop 702. The d-input of the flip-flop 702-1 is tied to a constant voltage potential, such as a high voltage level. The q-output of the flip-flop 702-1 is coupled to the d-input of the flip-flop 702-2 and corresponds to the first clock enable signal 406-1. The q-output of the flip-flop 702-2 is coupled to the d-input of the flip-flop 702-3 and corresponds to the second clock enable signal 406-2. The q-output of the flip-flop 702-3 corresponds to the third clock enable signal 406-3.

In an example operation, the clock-signal controller 106 asserts the clock adjustment indicator signal 206. Generally, an asserted signal can be driven high, and a non-asserted signal can be driven low. Alternatively, an asserted signal can be driven low, and a non-asserted signal can be driven high, depending on design. Here, an asserted signal is driven high. Thus, responsive to a rising edge of the clock adjustment indicator signal 206, the reset input (R) of each flip-flop 702 is triggered. With a triggered reset input (R), each flip-flop 702 drives its corresponding q-output low. Consequently, each clock enable signal 406 is driven low to de-assert a control input (not explicitly shown) of each clock gating circuit 404 (of FIG. 6) and cause each clock gating circuit 404 to gate the core clock signal 108.

After a frequency-adjustment operation 218 (e.g., of FIG. 3), the clock source 104 is oscillating the core clock signal 108 at an adjusted core frequency 208. Pulses are therefore arriving at the clocking inputs of the multiple flip-flops 702-1 to 702-3. Once the frequency-adjustment operation 218 is completed, the clock-signal controller 106 de-asserts the clock adjustment indicator signal 206. Thus, the reset input (R) of each flip-flop 702 is driven low, and each respective flip-flop 702 is therefore free to migrate a value on a respective d-input to a respective q-output. Upon the arrival of a first pulse of the core clock signal 108 at a clocking input of the flip-flop 702-1 after de-assertion of the clock adjustment indicator signal 206, the high voltage level is migrated from the d-input to the q-output of the flip-flop 702-1. Consequently, the first clock enable signal 406-1 is driven high so as to enable the corresponding clock gating circuit 404-1 (of FIG. 6). This enables the clock gating circuit 404-1 to release the first version of the core clock signal 308-1 to oscillate in accordance with the core clock signal 108. Note, however, that this first pulse of the core clock signal 108 does not change the low voltage values at the q-outputs of the flip-flops 702-2 and 702-3 because their respective d-inputs are still low at the time of arrival of the first pulse.

A delay period 412 is therefore implemented as a result of the flip-flops being triggered by the core clock signal 108. Thus, in this example, each delay period 412 has a duration equal to one clock cycle period. Upon the arrival of a second pulse of the core clock signal 108 at the clocking input of the flip-flop 702-2 after de-assertion of the clock adjustment indicator signal 206, the high voltage level of the first clock enable signal 406-1 is migrated from the d-input to the q-output of the flip-flop 702-2. Consequently, the second clock enable signal 406-2 is driven high so as to enable the corresponding clock gating circuit 404-2. After another delay period 412, the arrival of a third pulse of the core clock signal 108 at the clocking input of the flip-flop 702-3 causes the high voltage level at the d-input of the flip-flop 702-3 to be migrated to the q-output thereof. Consequently, the third clock enable signal 406-3 is driven high so as to enable the corresponding clock gating circuit 404-3 to release the third version of the core clock signal 308-3.

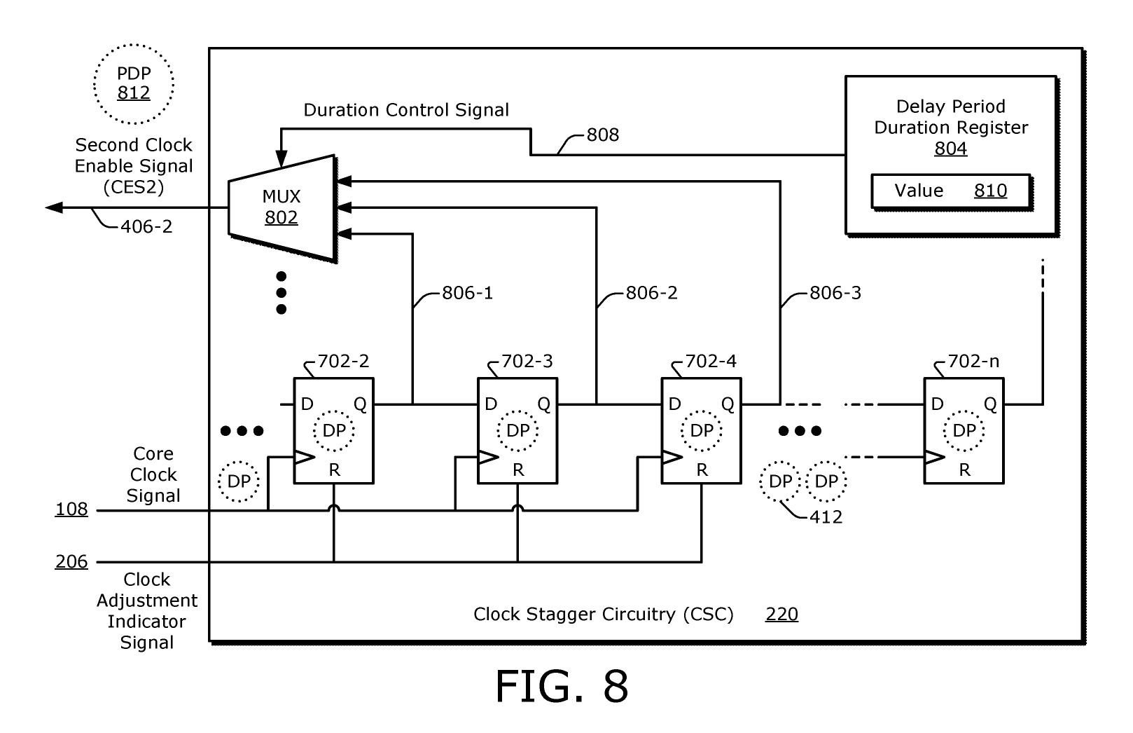

As shown in FIG. 7, each delay period 412 between assertions of successive clock enable signals 406 has a duration of one clock cycle period. However, each delay period 412 can have a different duration. For example, inserting an additional flip-flop 702 between the flip-flops 702-2 and 702-3 increases the corresponding delay period to two clock cycle periods. The example delay periods 412 in FIG. 7 have a fixed in length. However, the lengths of delay periods 412 can be variable with programmable durations as described with reference to FIG. 8.

FIG. 8 illustrates an example of clock stagger circuitry 220 with a programmable delay period 812 (PDP) associated with the second clock enable signal 406-2 for permitting the release of the second version of the core clock signal 308-2 (e.g., of FIG. 6). As shown, the chained series of flip-flops includes “n” flip-flops as indicated by the ellipses and as represented by the flip-flop 702-n, with “n” representing some positive integer. In addition to the last flip-flop 702-n, FIG. 8 explicitly depicts the flip-flop 702-2, the flip-flop 702-3, and a flip-flop 702-4. The clock stagger circuitry 220 further includes a multiplexer 802 (MUX) and a delay period duration register 804, which stores a value 810.

Based on the value 810, a duration control signal 808 is provided from the delay period duration register 804 to a control input of the multiplexer 802. Multiple selectable clock signals 806-1, 806-2, and 806-3 are respectively routed from the q-outputs of the multiple flip-flops 702-2, 702-3, and 702-4 to respective inputs of the multiplexer 802. An output of the multiplexer 802 provides the second clock enable signal 406-2. Although not shown in FIG. 8, additional multiplexers 802 can be implemented for additional clock enable signals, such as the third clock enable signal 406-3 of FIG. 7. Further, the first clock enable signal 406-1 can be provided from the q-output of the flip-flop 702-1, as shown in FIG. 7.

In example implementations, the value 810 is programmable to select an input of the multiplexer 802 for coupling to the output of the multiplexer 802 to establish the programmable delay period 812, which can be based on at least one delay period 412. Thus, the duration control signal 808 couples the value 810 to the control input of the multiplexer 802 to select one of the selectable clock signals 806-1 to 806-3 to be forwarded as the second clock enable signal 406-2. If the value 810 selects the lower input corresponding to the selectable clock signal 806-1, the second clock enable signal 406-2 experiences one delay period 412 after assertion of the first clock enable signal 406-1 (e.g., two total delay periods 412 since de-assertion of the clock adjustment indicator signal 206). If the value 810 selects the middle input corresponding to the selectable clock signal 806-2, the second clock enable signal 406-2 is provided two delay periods 412 after assertion of the first clock enable signal 406-1 (e.g., three total delay periods 412 since de-assertion of the clock adjustment indicator signal 206). If the value 810 selects the upper input corresponding to the selectable clock signal 806-3, the second clock enable signal 406-2 is asserted three delay periods 412 after assertion of the first clock enable signal 406-1 (e.g., four total delay periods 412 since de-assertion of the clock adjustment indicator signal 206).

Thus, the second clock enable signal 406-2 can be provided to the clock gating circuit 404-2 (of FIG. 6) with one delay period 412, two delay periods 412, or three delay periods 412 between an assertion of the first clock enable signal 406-1 and an assertion of the second clock enable signal 406-2. If equivalent delay periods are to be implemented between successive clock enable signals 406-2 and 406-3, three total delay periods, five total delay periods, or seven total delay periods can be selectable for the third clock enable signal 406-3 (not shown in FIG. 8). To do so, the inputs of another multiplexer (not shown) are coupled to the q-outputs of the flip-flop 702-3, a flip-flop 702-5, and a flip-flop 702-7, with flip-flops numbered greater than “702-4” not being explicitly depicted in FIG. 8 but being implied by the ellipses to be included in numerical order in the chained series of flip-flops.

The value 810 or another separate value (not shown) in the delay period duration register 804 or another register selects from among corresponding selectable clock signals for providing the third clock enable signal 406-3. The value causes the third clock enable signal 406-3 to be provided at some total programmable delay period 812 after the first clock enable signal 406-1 is asserted or some number of delay periods 412 after assertion of the second clock enable signal 406-2 by establishing a number of delay units 602 (of FIG. 6) between successive clock enable signals. Although these examples describe durations between successive clock enable signals that are of equal lengths, additional multiplexers and delay period duration registers, or values thereof, can be used to implement delay periods between successive clock enable signals that vary among the multiple clock enable signals 406-1 to 406-3.

FIG. 9 depicts an example signal timing diagram 900 that includes, from top to bottom, different clock signals, a control signal, multiple clock enable signals, and multiple versions of the core clock signal. The top three signals include: the internal clock signal 306, the core clock signal 108, and the clock adjustment indicator signal 206. The middle three signals include: the first clock enable signal 406-1, the second clock enable signal 406-2, and the third clock enable signal 406-3. The bottom three signals include: the first version of the core clock signal 308-1, the second version of the core clock signal 308-2, and the third version of the core clock signal 308-3. The description below of the signal timing diagram 900 references circuitry depicted in other figures.

At a time period 902, the core clock signal 108 is oscillating at a relatively low frequency. The multiple clock gating circuits 404-1, 404-2, and 404-3 are permitting these pulses to pass to respective ones of the multiple partitions 202-3, 202-2, and 202-1. Hence, the first, second, and third versions of the core clock signal 308-1, 308-2, and 308-3 are oscillating at the relatively low frequency mirroring the core clock signal 108.

At a time 904, the clock-signal controller 106 asserts the clock adjustment indicator signal 206. At a time 906, the first, second, and third clock enable signals 406-1, 406-2, and 406-3 are de-asserted based on the clock adjustment indicator signal 206. For example, the clock stagger circuitry 220 can drive low voltage levels on the clock enable signals based on multiple flip-flops 702-1 to 702-3 being reset by the asserted clock adjustment indicator signal 206. With the multiple clock enable signals 406-1 to 406-3 being de-asserted, the multiple clock gating circuits 404-1, 404-2, and 404-3 gate the oscillations of the core clock signal 108. Consequently, the first, second, and third versions of the core clock signal 308-1, 308-2, and 308-3 are driven low at a time 908.

With reference also to FIG. 3, at a time 910, the clock gating circuit 314 gates the core clock signal 108. The internal clock signal 306 is the product of one or more clock division operations performed by the clock divider 318 of the clock generator 312. At a time 912, a frequency of the internal clock signal 306 is increased. At a time 914, the clock gating circuit 314 ceases gating the core clock signal 108, and the core clock signal 108 restarts at a relatively high frequency based on the new frequency of the internal clock signal 306.

At a time 916, the clock-signal controller 106 de-asserts the clock adjustment indicator signal 206. This starts the implementation of at least one delay period 412 by the clock stagger circuitry 220. After a delay period 412-1 (DP), the delay unit 602-1 (of FIG. 6) asserts the first clock enable signal 406-1 at a time 918. At the next rising edge of the core clock signal 108 at a time 920, the clock gating circuit 404-1 releases the first version of the core clock signal 308-1 to propagate at the relatively high frequency towards the partition 202-3.

Meanwhile, after another delay period 412-2, which corresponds to the time 920, the delay unit 602-2 (of FIG. 6) asserts the second clock enable signal 406-2. At the next rising edge of the core clock signal 108 at a time 922, the clock gating circuit 404-2 releases the second version of the core clock signal 308-2 to propagate at the relatively high frequency towards the partition 202-2. After another delay period 412-3, which corresponds to the time 922, the delay unit 602-3 asserts the third clock enable signal 406-3. At the next rising edge of the core clock signal 108 at a time 924, the clock gating circuit 404-3 releases the third version of the core clock signal 308-3 to propagate at the relatively high frequency towards the partition 202-1.

In these manners, the first, second, and third versions of the core clock signal 308-1, 308-2, and 308-3 are restarted gradually at the times 920, 922, and 924. Accordingly, the respective corresponding partitions 202-3, 202-2, and 202-1 are reactivated sequentially at different times. Consequently, the rate of increase of current flow within the core 102 is managed so as to reduce a voltage droop of the power rail voltage 114 on the power rail 110.

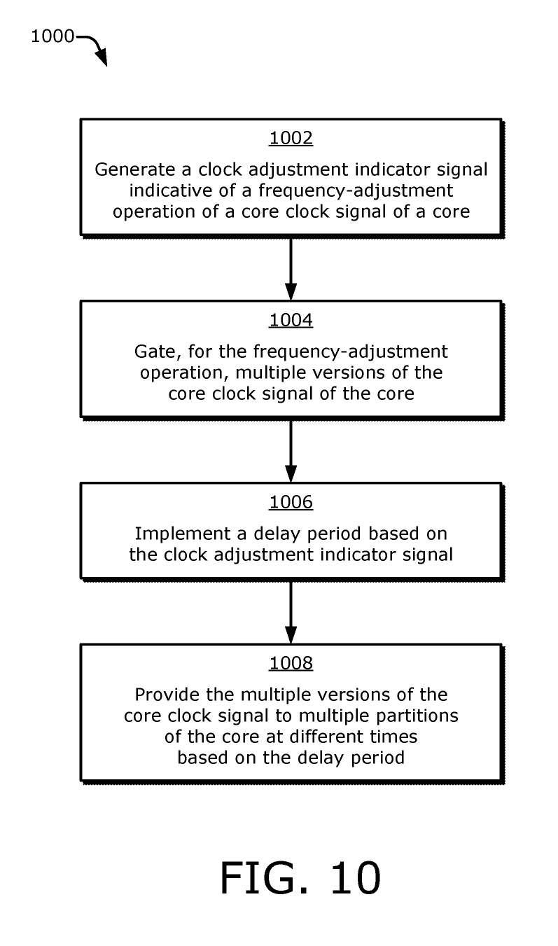

FIG. 10 is a flow diagram illustrating an example process 1000 for clock signal staggering with clock frequency adjustment. The process 1000 is described in the form of a set of blocks 1002-1008 that specify operations that can be performed. However, operations are not necessarily limited to the order shown in FIG. 10 or described herein, for the operations may be implemented in alternative orders or in fully or partially overlapping manners. Operations represented by the illustrated blocks of the process 1000 may be performed by an integrated circuit portion 200 of FIG. 2. More specifically, the operations of the process 1000 may be performed a clock-signal controller 106 and clock control circuitry 204 of FIG. 3.

At block 1002, a clock adjustment indicator signal indicative of a frequency-adjustment operation of a core clock signal of a core is generated. For example, an integrated circuit portion 200 can generate a clock adjustment indicator signal 206 indicative of a frequency-adjustment operation 218 of a core clock signal 108 of a core 102. For instance, based on receiving an adjust frequency command 224, a clock-signal controller 106 may generate the clock adjustment indicator signal 206 to indicate that the frequency-adjustment operation 218 is to begin to adjust a core frequency 208 of the core clock signal 108.

At block 1004, for the frequency-adjustment operation, multiple versions of the core clock signal of the core are gated. For example, the integrated circuit portion 200 can gate, for the frequency-adjustment operation 218, multiple versions of the core clock signal 308-1 to 308-3 of the core 102. The gating may be performed within the core 102 by clock gating circuitry 222 that includes multiple clock gating circuits 404-1 to 404-3. An example implementation of the gating at block 1004 can include gating respective versions of the multiple versions of the core clock signal 308-1 to 308-3 using respective clock gating circuits 404-1 to 404-3 that are configured to be individually controlled, such as by individual respective clock enable signals 406-1 to 406-3.

At block 1006, a delay period is implemented based on the clock adjustment indicator signal. For example, the integrated circuit portion 200 can implement a delay period 412 based on the clock adjustment indicator signal 206. To do so, clock stagger circuitry 220 may utilize at least one delay unit 602 to cause a delay period 412 to elapse between restarting two different versions of the core clock signal (e.g., a first version of the core clock signal 308-1 and a second version of the core clock signal 308-2) responsive to de-assertion of the clock adjustment indicator signal 206.

At block 1008, the multiple versions of the core clock signal are provided to multiple partitions of the core at different times based on the delay period. For example, the integrated circuit portion 200 can provide the multiple versions of the core clock signal 308-1 to 308-3 to multiple partitions 202-1 to 203-3 of the core 102 at different times based on the delay period 412. For instance, the clock gating circuitry 222 may release the multiple versions of the core clock signal 308-1 to 308-3 in a staggered fashion based on the delay period 412 such that the multiple partitions 202-1 to 202-3 of the core 102 are reactivated at different times in any order.

Example implementations of the process 1000 can additionally include an operation of performing the frequency-adjustment operation 218 on the core clock signal 108 using a clock divider 318. Further, the providing operation of block 1008 can include sequentially releasing the multiple versions of the core clock signal 308-1 to 308-2 after the frequency-adjustment operation 218 is performed to sequentially reactivate partitions of the multiple partitions 202-1 to 202-3 in any order.

Example implementations of the process 1000 can include implementing the delay period of block 1006 by implementing multiple delay periods 412 that begin to elapse responsive to a de-assertion of the clock adjustment indicator signal 206. Further, the providing operation of block 1008 can include, for instance, providing the multiple versions of the core clock signal 308-1 to 308-3 to the multiple partitions 202-3 to 202-1, respectively, of the core 102 at different times based on the multiple delay periods 412. Example implementations of the process 1000 can additionally include storing a value 810 that is indicative of a duration for at least one delay period 412, with the at least one delay period 412 functioning as a programmable delay period 812.

In some example implementations of the process 1000, the gating operation of block 1004 can include deactivating the multiple partitions 202-1 to 202-3 of the core 102. Further, the providing operation of block 1008 can include sequentially reactivating the multiple partitions 202-1 to 202-3 of the core 102 in any order using the multiple versions of the core clock signal 308-1 to 308-3 after the frequency-adjustment operation 218 is performed.

In some example implementations regarding the process 1000, the multiple partitions of the core 102 can include a first partition 202-1 and a second partition 202-2, and the multiple versions of the core clock signal 108 can include a first version of the core clock signal 308-1 and a second version of the core clock signal 308-2. Further, the providing operation of block 1008 can include enabling the second version of the core clock signal 308-2 to propagate to the second partition 202-2 and enabling the first version of the core clock signal 308-1 to propagate to the first partition 202-1 Additionally, the implementing the delay period operation of block 1006 can include waiting the delay period 412 between the enabling of the second version of the core clock signal 308-2 and the enabling of the first version of the core clock signal 308-1.

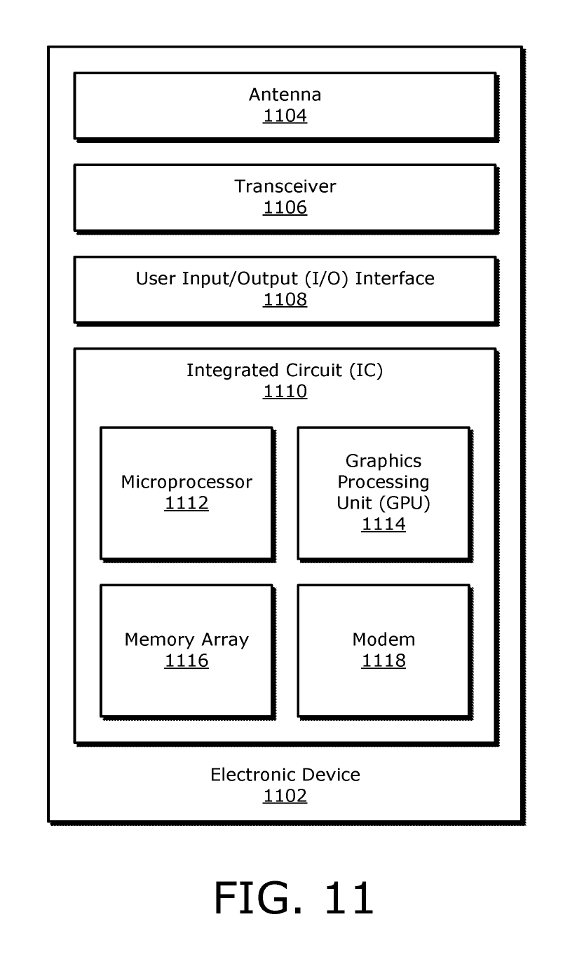

FIG. 11 depicts an example electronic device 1102 that includes an integrated circuit (IC) 1110 having multiple cores. As shown, the electronic device 1102 includes an antenna 1104, a transceiver 1106, and a user input/output (I/O) interface 1108 in addition to the integrated circuit 1110. Illustrated examples of the integrated circuit 1110, or cores thereof, include a microprocessor 1112, a graphics processing unit (GPU) 1114, a memory array 1116, and a modem 1118. In one or more implementations, clock signal staggering with clock frequency adjustment as described herein can be implemented by the integrated circuit 1110 as a hardware-oriented current management technique.

The electronic device 1102 can be a mobile or battery-powered device or a fixed device that is designed to be powered by an electrical grid. Examples of the electronic device 1102 include a server computer, a network switch or router, a blade of a data center, a personal computer, a desktop computer, a notebook or laptop computer, a tablet computer, a smart phone, an entertainment appliance, or a wearable computing device such as a smartwatch, intelligent glasses, or an article of clothing. An electronic device 1102 can also be a device, or a portion thereof, having embedded electronics. Examples of the electronic device 1102 with embedded electronics include a passenger vehicle, industrial equipment, a refrigerator or other home appliance, a drone or other unmanned aerial vehicle (UAV), or a power tool.

For an electronic device with a wireless capability, the electronic device 1102 includes an antenna 1104 that is coupled to a transceiver 1106 to enable reception or transmission of one or more wireless signals. The integrated circuit 1110 may be coupled to the transceiver 1106 to enable the integrated circuit 1110 to have access to received wireless signals or to provide wireless signals for transmission via the antenna 1104. The electronic device 1102 as shown also includes at least one user I/O interface 1108. Examples of the user 1/O interface 1108 include a keyboard, a mouse, a microphone, a touch-sensitive screen, a camera, an accelerometer, a haptic mechanism, a speaker, a display screen, or a projector.

The integrated circuit 1110 may comprise, for example, one or more instances of a microprocessor 1112, a GPU 1114, a memory array 1116, a modem 1118, and so forth. The microprocessor 1112 may function as a central processing unit (CPU) or other general-purpose processor. Some microprocessors include different parts, such as multiple processing cores, that may be individually powered on or off. The GPU 1114 may be especially adapted to process visual-related data for display, such as video data images. If visual-related data is not being rendered or otherwise processed, the GPU 1114 may be fully or partially powered down. The memory array 1116 stores data for the microprocessor 1112 or the GPU 1114. Example types of memory for the memory array 1116 include random access memory (RAM), such as dynamic RAM (DRAM) or static RAM (SRAM); flash memory; and so forth. If programs are not accessing data stored in memory, the memory array 1116 may be powered down overall or block-by-block. The modem 1118 demodulates a signal to extract encoded information or modulates a signal to encode information into the signal. If there is no information to decode from an inbound communication or to encode for an outbound communication, the modem 1118 may be idled to reduce power consumption. The integrated circuit 1110 may include additional or alternative parts than those that are shown, such as an I/O interface, a sensor such as an accelerometer, a transceiver or another part of a receiver chain, a customized or hard-coded processor such as an application-specific integrated circuit (ASIC), and so forth.

The integrated circuit 1110 may also comprise a system on a chip (SOC). An SOC may integrate a sufficient number of different types of components to enable the SOC to provide computational functionality as a notebook computer, a mobile phone, or another electronic apparatus using one chip, at least primarily. Components of an SOC, or an integrated circuit 1110 generally, may be termed cores or circuit blocks. A core or circuit block of an SOC may be powered down at least partially to facilitate a clock frequency adjustment, and then gradually reactivated in a staggered fashion across multiple partitions of the core, according to the techniques described in this document. Examples of cores or circuit blocks include, in addition to those that are illustrated in FIG. 11, a voltage regulator, a main memory or cache memory block, a memory controller, a general-purpose processor, a cryptographic processor, a video or image processor, a vector processor, a radio, an interface or communications subsystem, a wireless controller, or a display controller. Any of these cores or circuit blocks, such as a central processing unit or a multimedia processor, may further include multiple internal cores or circuit blocks.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Further, items represented in the accompanying figures and terms discussed herein may be indicative of one or more items or terms, and thus reference may be made interchangeably to single or plural forms of the items and terms in this written description. Finally, although subject matter has been described in language specific to structural features or methodological operations, it is to be understood that the subject matter defined in the appended claims is not necessarily limited to the specific features or operations described above, including not necessarily being limited to the organizations in which features are arranged or the orders in which operations are performed.

What is claimed is:

1. An integrated circuit comprising:
a clock source configured to produce a core clock signal having a core frequency, the clock source configured to perform an adjustment of the core frequency;
a clock-signal controller configured to generate a clock adjustment indicator signal indicative of the adjustment of the core frequency of the core clock signal; and
a core coupled to the clock source and configured to receive the core clock signal, the core including:
multiple partitions configured to perform operations responsive to oscillation of the core clock signal at the core frequency; and
clock stagger circuitry coupled to the clock-signal controller and configured to receive the clock adjustment indicator signal, the clock stagger circuitry configured to sequentially provide the core clock signal to individual partitions of the multiple partitions based on the clock adjustment indicator signal.

2. The integrated circuit of claim 1, wherein the clock stagger circuitry is configured to produce multiple clock enable signals that are delayed with respect to each other based on the clock adjustment indicator signal, each clock enable signal of the multiple clock enable signals respectively corresponding to a partition of the multiple partitions.

3. The integrated circuit of claim 2, wherein the core includes:
multiple clock gating circuits coupled to the clock stagger circuitry, each clock gating circuit configured to receive the core clock signal and a respective clock enable signal of the multiple clock enable signals, each respective clock gating circuit configured to gate the core clock signal based on the respective clock enable signal.

4. The integrated circuit of claim 3, wherein:
each respective clock gating circuit of the multiple clock gating circuits is coupled to a respective partition of the multiple partitions; and
each respective clock gating circuit is configured to provide a version of the core clock signal to the respective partition responsive to the respective clock enable signal being in an asserted state.

5. The integrated circuit of claim 4, wherein:
the core includes a data buffer coupled between two consecutive partitions of the multiple partitions; and
the data buffer is configured to transfer data between the two consecutive partitions responsive to oscillation of two versions of the core clock signal provided by two clock gating circuits of the multiple clock gating circuits.

6. The integrated circuit of claim 2, wherein the clock stagger circuitry includes multiple delay units coupled together in series, each respective delay unit configured to provide a respective clock enable signal of the multiple clock enable signals.

7. The integrated circuit of claim 6, wherein the multiple delay units are configured to operate responsive to oscillation of the core clock signal.

8. The integrated circuit of claim 7, wherein the multiple delay units comprise multiple flip-flops configured to trigger responsive to an edge of a pulse produced by the oscillation of the core clock signal.

9. The integrated circuit of claim 6, wherein the clock stagger circuitry includes a register, the register configured to be programmable with a value that establishes a number of delay units between successive clock enable signals of the multiple clock enable signals.

10. The integrated circuit of claim 1, wherein the clock source comprises:
a phase-locked loop (PLL) configured to generate a baseline clock signal; and
a clock generator configured to generate an internal clock signal at an adjustable frequency using the baseline clock signal,
wherein the clock source is configured to output the core clock signal based on the internal clock signal.

11. The integrated circuit of claim 10, wherein:
the clock source includes a clock gating circuit configured to gate the core clock signal during the adjustment of the core frequency; and
the clock-signal controller is integrated with the clock source.

12. The integrated circuit of claim 1, wherein the multiple partitions are arranged into a data path of the core.

13. The integrated circuit of claim 12, wherein the data path comprises a data processing pipeline of the core, the data processing pipeline configured to transform data into processed data.

14. The integrated circuit of claim 12, wherein the core includes a data buffer configured to transfer data between consecutive partitions along the data path responsive to oscillation of the core clock signal.

15. The integrated circuit of claim 14, further comprising:
a communication clock generator configured to generate a communication clock signal; and
a communication pathway coupled to the core, the communication pathway configured to operate based on the communication clock signal,
wherein the core includes another data buffer configured to transfer data between a partition of the multiple partitions and the communication pathway responsive to oscillation of the communication clock signal and oscillation of the core clock signal.

16. An integrated circuit comprising:
a clock source configured to produce a core clock signal and to adjust a core frequency of the core clock signal;
a clock-signal controller configured to generate a clock adjustment indicator signal indicative of an adjustment of the core frequency; and
a core coupled to the clock source and the clock-signal controller, the core configured to receive the core clock signal and the clock adjustment indicator signal, the core further configured to operate based on the core frequency of the core clock signal, the core including:
multiple partitions configured to perform operations responsive to oscillation of the core clock signal; and
means for staggering release of the core clock signal to individual partitions of the multiple partitions based on the clock adjustment indicator signal.

17. The integrated circuit of claim 16, wherein the means for staggering comprises means for delaying propagation of oscillations of the core clock signal.

18. The integrated circuit of claim 17, wherein the means for delaying comprises means for enabling propagation of the oscillations of the core clock signal after a delay period that is based on a clock cycle duration of the core clock signal.

19. The integrated circuit of claim 16, wherein the core includes:
means for gating multiple versions of the core clock signal during the adjustment of the core frequency, the means for gating coupled to the means for staggering and configured to release the multiple versions of the core clock signal to the multiple partitions based on the clock adjustment indicator signal.

20. The integrated circuit of claim 16, wherein:
the multiple partitions are coupled in series along a data path of the core; and
the core includes means for buffering data between consecutive partitions of the multiple partitions.

21. The integrated circuit of claim 16, further comprising:
means for asserting the clock adjustment indicator signal at least while the clock source adjusts the core frequency of the core clock signal and for de-asserting the clock adjustment indicator signal after the core frequency is adjusted, wherein
the means for staggering is configured to enable release of the core clock signal responsive to de-assertion of the clock adjustment indicator signal.

22. A method for clock signal staggering with clock frequency adjustment, the method comprising:
generating a clock adjustment indicator signal indicative of a frequency-adjustment operation of a core clock signal of a core;
gating, for the frequency-adjustment operation, multiple versions of the core clock signal of the core;
implementing a delay period based on the clock adjustment indicator signal; and
providing the multiple versions of the core clock signal to multiple partitions of the core at different times based on the delay period.

23. The method of claim 22, further comprising:
performing the frequency-adjustment operation on the core clock signal using a clock divider,
wherein the providing comprises sequentially releasing the multiple versions of the core clock signal after the frequency-adjustment operation is performed to sequentially reactivate partitions of the multiple partitions.

24. The method of claim 22, wherein the gating comprises gating respective versions of the multiple versions of the core clock signal using respective clock gating circuits that are configured to be individually controlled.

25. The method of claim 22, wherein:
the implementing comprises implementing multiple delay periods that begin to elapse responsive to a de-assertion of the clock adjustment indicator signal; and
the providing comprises providing the multiple versions of the core clock signal to the multiple partitions of the core at the different times based on the multiple delay periods.

26. The method of claim 22, wherein:
the multiple partitions include a first partition and a second partition;
the multiple versions of the core clock signal include a first version and a second version;
the providing comprises:
enabling the second version of the core clock signal to propagate to the second partition; and
enabling the first version of the core clock signal to propagate to the first partition; and
the implementing comprises waiting the delay period between the enabling of the second version and the enabling of the first version.

27. The method of claim 22, wherein:
the gating comprises deactivating the multiple partitions of the core; and
the providing comprises sequentially reactivating the multiple partitions of the core using the multiple versions of the core clock signal after the frequency-adjustment operation is performed.

28. The method of claim 22, further comprising:
storing a value indicative of a duration for the delay period, the delay period comprising a programmable delay period.

29. An integrated circuit comprising:
a clock source configured to perform a frequency-adjustment operation on a core frequency of a core clock signal; and
a core coupled to the clock source and configured to receive the core clock signal, the core configured to operate based on the core frequency of the core clock signal, the core including:
clock control circuitry configured to generate a first version of the core clock signal using the core clock signal and a second version of the core clock signal using the core clock signal, the clock control circuitry configured to delay forwarding of the first version relative to the second version after a performance of the frequency-adjustment operation;
a first partition coupled to the clock control circuitry and configured to operate responsive to the first version of the core clock signal; and
a second partition coupled to the clock control circuitry and configured to operate responsive to the second version of the core clock signal.

30. The integrated circuit of claim 29, wherein the clock control circuitry is configured to resume forwarding of the second version of the core clock signal before resuming forwarding of the first version of the core clock signal such that the second partition is reactivated prior to the first partition after the performance of the frequency-adjustment operation.
